(19) United States
(12) Patent Application Publication
(10) Pub. No.: US 2014/0132896 A1
(43) Pub. Date: May 15, 2014

(54) POLARIZER, LIQUID CRYSTAL DISPLAY AND MANUFACTURING METHOD THEREOF

(71) Applicant: Samsung Display Co., Ltd., Yongin-City (KR)

(72) Inventors: Nak Cho CHOI, Hwaseong-si (KR); Jae Cheol PARK, Hwaseong-si (KR); Seung Beom PARK, Hwaseong-si (KR); Gyeong Eun EOH, Seoul (KR); Yun JANG, Hwaseong-si (KR)

(73) Assignee: Samsung Display Co., Ltd., Yongin-City (KR)

(21) Appl. No.: 14/071,554

(22) Filed: Nov. 4, 2013

(30) Foreign Application Priority Data
Nov. 14, 2012 (KR) 10-2012-0129154

(51) Int. Cl. G02F 1/1335

(52) U.S. Cl. CPC G02F 1/133528
USPC 349/96; 445/24

(57) ABSTRACT

Provided are a liquid crystal display including a liquid crystal display panel comprising a first substrate and a liquid crystal layer, an upper polarizer disposed on the liquid crystal display, a lower polarizer disposed under the liquid crystal display, and a first phase delay layer located on the liquid crystal display panel, configured to compensate for a phase delay value in a thickness direction and comprising parylene.

### CROSS-REFERENCE TO RELATED APPLICATION

This application claims priority to and the benefit of Korean Patent Application No. 10-2012-0129154 filed in the Korean Intellectual Property Office on Nov. 14, 2012, the entire contents of which are incorporated herein by reference.

### BACKGROUND

(a) Technical Field

Embodiments of the present invention relate generally to a polarizer, a liquid crystal display, and a manufacturing method thereof.

(b) Description of the Related Art

Currently, a liquid crystal display is one of flat panel displays which are most widely used, and includes two display panels, in which electric field generating electrodes such as a pixel electrode, a common electrode and the like are formed, and a liquid crystal layer inserted between the two display panels. The liquid crystal display displays an image by applying a voltage to the electric field generating electrodes to generate an electric field in the liquid crystal layer, determining orientations of liquid crystal molecules of the liquid crystal layer through the generated electric field, and controlling polarization of an incident light.

Among the liquid crystal displays, a vertical alignment (VA) mode liquid crystal display where a long axis of the liquid crystal module is located to perpendicular to top and bottom display panels in a state where an electric field is not applied is spotlighted due to a high contrast ratio and an easy implementation of a wide standard view angle.

Meanwhile, the vertical alignment (VA) mode liquid crystal display has different phase delay values provided by the liquid molecules according to a position viewed from the user, and thus additionally uses a compensation film to compensate the different phase delay values. Since different phase delay values according to various positions of users should be compensated by the compensation film, a biaxial film having different refractive indexes for each direction is used as the compensation film. The biaxial film is manufactured while changing refractive indexes in two directions, so that there are disadvantages in that a price thereof is high and a cost of the manufactured liquid crystal display also increases.

The above information disclosed in this Background section is only for enhancement of understanding of the background of the invention and therefore it may contain information that does not form the prior art that is already known in this country to a person of ordinary skill in the art.

### SUMMARY

Embodiments of the present invention have been made in an effort to provide a polarizer and a liquid crystal display which can compensate for different phase delay values provided by liquid crystal molecules with lower costs.

An exemplary embodiment of the present invention provides a liquid crystal display including a liquid crystal display panel comprising a first substrate and a liquid crystal layer, an upper polarizer disposed on the liquid crystal display, a lower polarizer disposed under the liquid crystal display, and a first phase delay layer located on the liquid crystal display panel, configured to compensate for a phase delay value in a thickness direction and comprising parylene.

The liquid crystal display may further comprise a second substrate formed opposite to the first substrate and having the liquid crystal layer between the first substrate and the second substrate.

The first phase delay layer may be deposited on the liquid crystal panel.

The first phase delay layer may be directly deposited on the liquid crystal panel without an intervening adhesive layer.

The first phase delay layer may have an out-of-plane retardation value equal to or greater than a half of the retardation value of the liquid crystal and equal to or less than 1.5 times of the retardation value of the liquid crystal.

The liquid crystal display may further comprises a second substrate formed opposite to the first substrate and having the liquid crystal layer between the first substrate and the second substrate, a second phase delay layer located on the liquid crystal display panel where the first phase delay layer is not formed, and configured to compensate for a phase delay value in a thickness direction.

The second phase delay layer may comprise parylene.

The second phase delay layer may be deposited on the second substrate.

The second phase delay layer may be directly deposited on the second substrate without an intervening adhesive layer.

Each of the upper phase delay layer and the lower phase delay layer may have an out-of-plane retardation value equal to or greater than a quarter of the retardation value of the liquid crystal and equal to or less than 0.75 times of the retardation value of the liquid crystal.

The liquid crystal display may further comprise a microcavity layer supported by a roof layer formed on the first substrate, and the liquid crystal layer is located within the microcavity layer.

The liquid crystal display may further comprise a second phase delay layer disposed on the roof layer, and configured to compensate for a phase delay value in a thickness direction.

Yet another exemplary embodiment of the present invention provides a method of manufacturing a liquid crystal display, the method including: forming a phase delay layer by depositing parylene on a liquid crystal display panel, and attaching a uniaxial polarizer on the deposited phase delay layer, in which the phase delay layer compensates for an out-of-plane phase delay value.

The forming of the phase delay layer may include depositing the parylene in a state where the liquid crystal display panel is supported by a support member having an opening, wherein the opening corresponds to an area where the parylene is deposited in the liquid crystal display panel.

The forming of the phase delay layer may include depositing the parylene by reducing a temperature of the area where the parylene is deposited and increasing a temperature of an area where the parylene is not deposited, wherein a heating and a cooling is performed by a thermoelectric element having a heating part and a cooling part. The forming of the phase delay layer comprises forming a phase delay layer on both side of the liquid crystal display panel and the attaching a uniaxial polarizer comprises attaching an uniaxial polarizer on both side of the liquid crystal panel.

According to an embodiment of the present invention, it is possible to form a polarizer having a low manufacturing cost by forming parylene in one surface of a uniaxial polarizer and reduce a manufacturing cost of a liquid crystal display by manufacturing the liquid crystal display by using the polarizer having the low manufacturing cost.

### BRIEF DESCRIPTION OF THE DRAWINGS

FIG. 1 is a cross-sectional view of a liquid crystal display according to an exemplary embodiment of the present invention.

FIG. 2 illustrates a chemical formula of parylene according to an exemplary embodiment of the present invention.

FIG. 3 illustrates a method of manufacturing parylene according to an exemplary embodiment of the present invention.

FIGS. 4 to 7 are graphs illustrating parylene characteristics.

FIGS. 7 to 9 are diagrams for describing a method of compensating a delay value in a liquid crystal display according to an exemplary embodiment of the present invention.

FIGS. 10A to 19 are diagrams illustrating characteristics of a liquid crystal display according to an exemplary embodiment of the present invention.

FIGS. 20 and 21 are cross-sectional views of a liquid crystal display according to another exemplary embodiment of the present invention.

FIGS. 22 to 24 are diagrams illustrating a liquid crystal display and a polarizer according to another exemplary embodiment of the present invention.

FIGS. 25 to 31 illustrate a method of depositing parylene according to an exemplary embodiment of the present invention.

### DETAILED DESCRIPTION OF THE EMBODIMENTS

Aspects of the embodiments will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

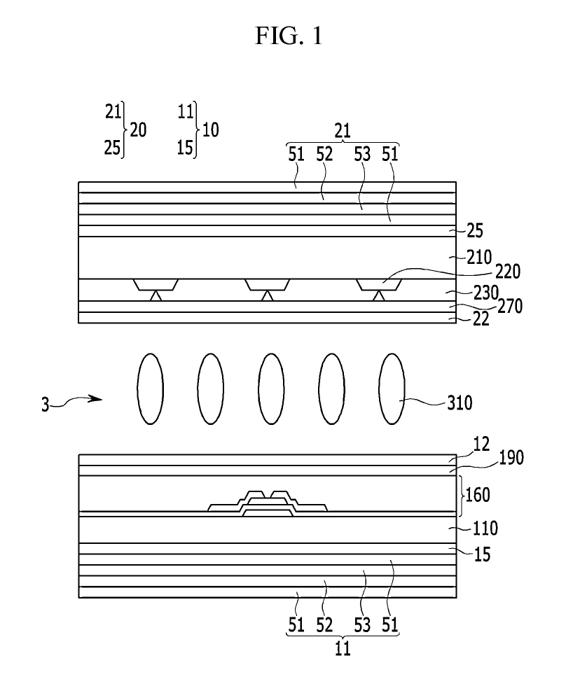

Hereinafter, a liquid crystal display according to an exemplary embodiment of the present invention will be described in detail with reference to FIG. 1.

FIG. 1 is a cross-sectional view of a liquid crystal display according to an exemplary embodiment of the present invention.

The liquid crystal display according to an exemplary embodiment of the present invention includes an upper display panel, a lower display panel, and a liquid crystal layer 3 injected between the two display panels.

The lower display panel includes a thin film transistor (TFT) 160 formed on a lower insulation substrate 110 and a pixel electrode 190 formed on the thin film transistor 160 and connected to an output terminal of the thin film transistor 160.

A lower alignment layer 12 is formed on the pixel electrode 190.

Meanwhile, a lower polarizer 10 is formed under the lower insulation substrate 110, and the lower polarizer 10 includes a lower phase delay layer 15 and a lower uniaxial polarizer 11.

Meanwhile, the upper display panel includes a light blocking member 220 having an opening formed under an upper insulation substrate 210 and a color filter 230 formed under the light blocking member 220. The color filter 230 may be located at the region corresponding to the opening of the light blocking member 220. A common electrode 270 is formed under the color filter 230. The common electrode 270 generates an electric field with the pixel electrode 190.

An upper alignment layer 22 is formed under the common electrode 270. The upper alignment layer 22 and the lower alignment layer 12 set alignment directions of liquid crystal molecules 310, and the alignment directions of the liquid crystal molecules, which are vertically arranged, are changed by the electric field generated by the pixel electrode 190 and the common electrode 270.

An upper polarizer 20 is formed on the upper insulation substrate 210, and the upper polarizer 20 includes an upper phase delay layer 25 and an upper uniaxial polarizer 21.

The upper polarizer 20 and the lower polarizer 10 according to an exemplary embodiment of the present invention include a uniaxial polarizer for compensating for a delay value in a Ro direction (in-plane phase delay value) and a phase delay layer for compensating for a delay value in a Rth direction (phase delay value in a thickness direction) with low cost.

The uniaxial polarizers 11 and 21 are attached to the upper and/or the lower insulation substrates in a film type and compensate for only the in-plane phase delay To compensate for the out of plane phase delay, a biaxial compensation characteristic, which have different refractive indexes along the x-axis, y-axis and z-axis, is needed. A biaxial film is formed by elongation of a film in two directions, and the manufacturing cost is high. However, the uniaxial polarizers is formed by elongation of a film in only one direction because it has only one axis having a different refractive index among the three axes of nx, ny, and nz, so that the manufacturing cost is low.

Accordingly, in an exemplary embodiment of the present invention, the cheap uniaxial polarizers 11 and 21 having the uniaxial compensation characteristic are used to compensate for an in-plane retardation of a liquid crystal. Instead, the out-of-plane compensation is performed using phase delay layers 15 and 25 formed on the upper and/or the lower insulation substrates.

The uniaxial polarizers 11 and 21 according to an exemplary embodiment of the present invention include poly vinyl alcohol (PVA) layers 52 and the a-plates 53 inserted between triacetate cellulose (TAC) layers disposed in both sides as illustrated in FIG. 1. A position between the PVA layer 52 and the a-plate 53 may vary according to an exemplary embodiment, and the PVA layer 52 is formed above the a-plate 53 in the present exemplary embodiment.

The phase delay layers 15 and 25 according to an exemplary embodiment of the present invention are formed by depositing parylene on the upper and/or the lower insulation substrates. Since the thickness of the phase delay layers 15 and 25 determine the out-of plane retardation value Rth (phase delay value in the thickness direction) according to a thickness of the deposited parylene, once the delay value to be compensated for is determined, the phase delay layers 15 and 25 may be formed by depositing parylene having a proper thickness. As a result, the phase delay layers 15 and 25 may easily have the appropriate compensation characteristics. The phase delay layer may have a sum of out-of-plane retardation value equal to or greater than a half of the retardation value of the liquid crystal and equal to or less than 1.5 times of the retardation value of the liquid crystal. Thus, when the phase delay layer is formed on both side of the display panel, the out-of-plane retardation value of each side of the display panel may have equal to or greater than a quarter of the retardation value of the liquid crystal and equal to or less than 0.75 times of the retardation value of the liquid crystal.

According to exemplary embodiments, directions of transmission axes of the upper polarizer 20 and the lower polarizer 10 may be perpendicular or parallel to each other.

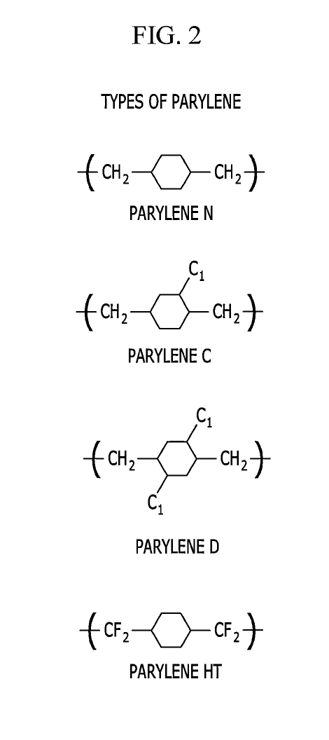

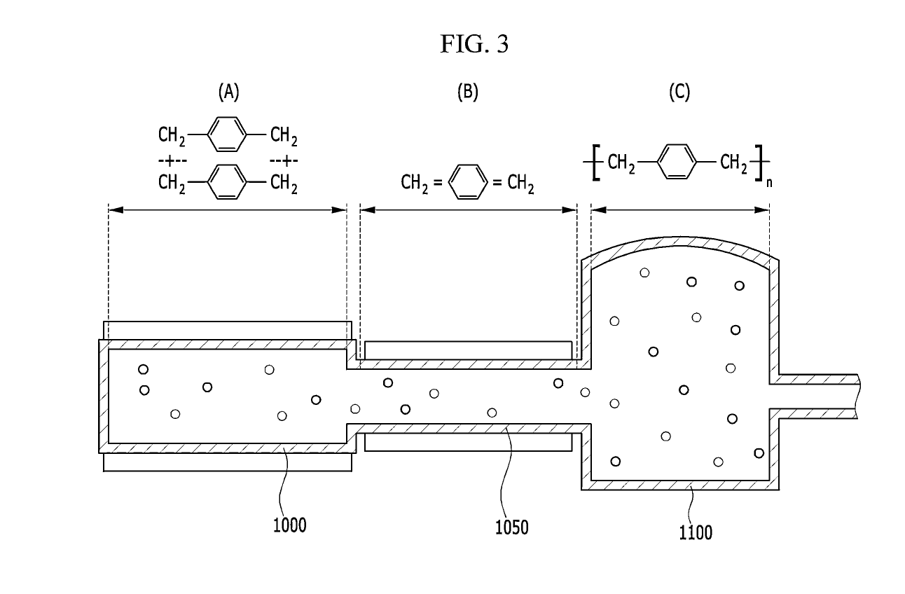

Hereinafter, parylene will be described with reference to FIGS. 2 and 3.

FIG. 2 illustrates a chemical formula of parylene according to an exemplary embodiment of the present invention, and FIG. 3 illustrates a method of manufacturing parylene according to an exemplary embodiment of the present invention.

Referring to FIG. 2, representative examples of parylenes used in an exemplary embodiment of the present invention include parylene N, parylene C, parylene D, and parylene HT. FIG. 2 shows a chemical formula of each parylenes.

Parylene may be manufactured by the method illustrated in FIG. 3.

In FIG. 3, a reference numeral 1000 and a reference numeral 1050 indicate a first heat treatment part and a second heat treatment part. The first heat treatment part sublimates parylene dimer to gas phase monomer through heat treatment at a temperature of 100 degrees or higher. The second heat treatment part pyrolyzes gas phase monomer through heat treatment at a temperature of 500 degrees or higher. In FIG. 3, a reference numeral 1100 indicates a room temperature reactor, and the room temperature reactor 1100 has a room temperature to perform solid state polymerization.

In the method of manufacturing parylene according to an exemplary embodiment of FIG. 3, a parylene dimer having a chemical formula of FIG. 3(A) in a solid state and the like is first injected into the first heat treatment part 1000.

The parylene dimer of FIG. 3(A) is changed from a solid state to a gas state through sublimation at a temperature of 100 degrees or higher.

The parylene dimer of FIG. 3(A) having the gas phase enters into the second heat treatment part 1050 and is pyrolyzed at a temperature of 500 degrees or higher to be a radical monomer having a chemical formula of FIG. 3(B).

Thereafter, the radical monomer of FIG. 3(B) having been pyrolyzed is enter into the room temperature reactor 1100 and is solid-state polymerized at a room temperature in a low pressure, so that parylene N of FIG. 3(C) is generated.

Parylene C and parylene D may be generated by changing the source material.

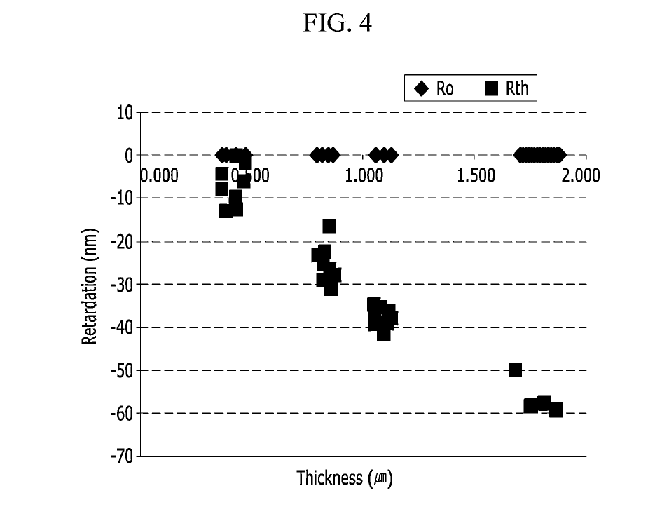

The parylene characteristics will be described with reference to FIGS. 4 to 7.

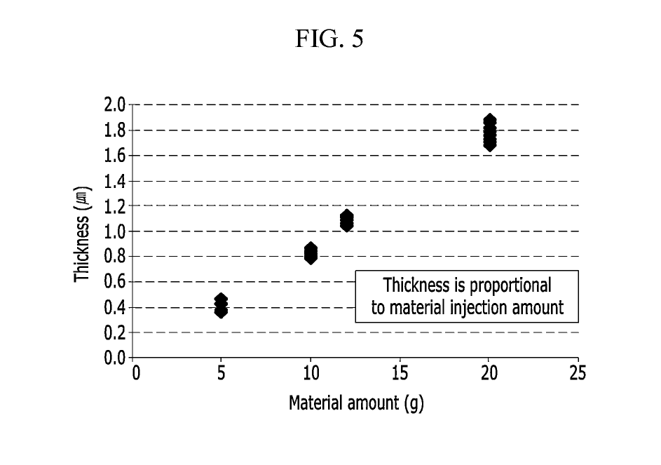

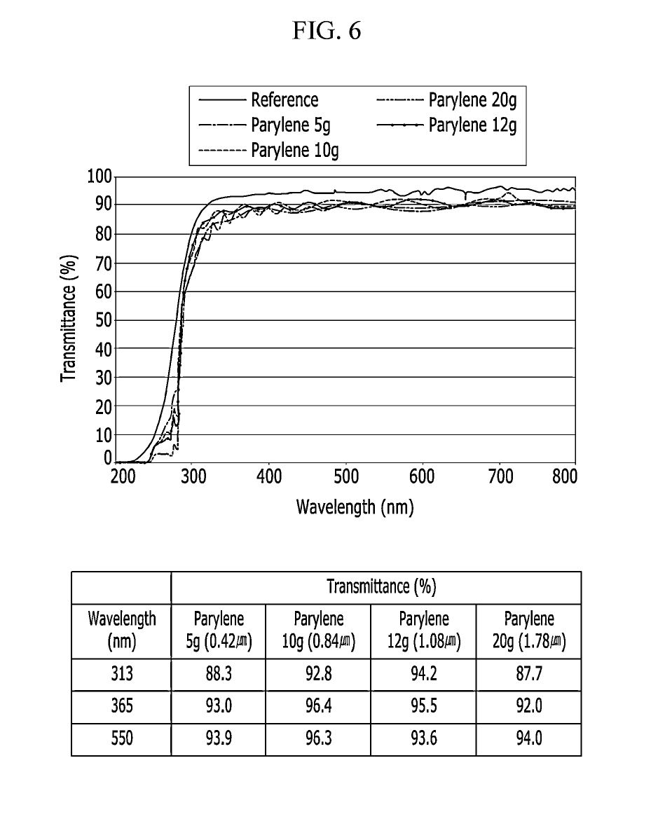

FIGS. 4 to 7 illustrate graphs showing characteristics of the parylene. FIG. 4 is a graph illustrating a change in the phase delay values (Ro and Rth) according to a thickness of deposited parylene. FIG. 5 is a graph illustrating an amount of deposited parylene and a thickness of deposited parylene. FIG. 6 is a graph illustrating transmittance according to an amount or a thickness of deposited parylene.

As illustrated in FIG. 4, it can be known that the in-plane retardation value Ro is constant but out-of-plane retardation value Rth increase as a thickness of parylene is thicker. That is, the phase delay layers 15 and 25 formed using parylene do not influence the in-plane retardation value Ro but influence only the out-of-plane retardation value Rth. Once the phase delay values to be compensated for by the phase delay layers 15 and 25 are determined, a thickness of the parylene to be deposited can be determined.

FIG. 5 shows a thickness of deposited parylene according to a material amount used to deposit parylene. According to FIG. 5, it can be known that the thickness of deposited parylene is proportional to the amount of material used to deposit the parylene.

Accordingly, once the phase delay values to be compensated for by the phase delay layers 15 and 25 are determined, the thickness is determined according to the phase delay values. When the parylene is deposited with the corresponding thickness, the phase delay layers 15 and 25 may be formed by simply depositing parylene with the corresponding material amount.

Meanwhile, FIG. 6 shows transmittance of a parylene layer formed of various material amounts (or thicknesses). Since the parylene layer has transmittance of about 90% in a visible ray, the parylene layer is considered as being transparent although the transmittance is slightly lower than that of the glass, so that the parylene layer can be used in a display device.

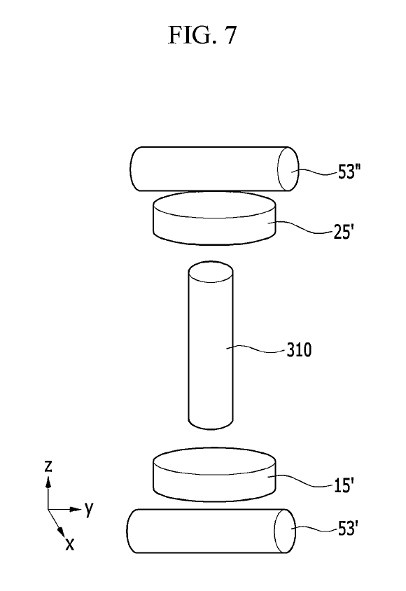

Hereinafter, a method of compensating a phase delay value according to an exemplary embodiment of the present invention will be described with reference to FIGS. 7 to 9.

FIGS. 7 to 9 illustrate the method of compensating for the phase delay value in the liquid crystal display according to an exemplary embodiment of the present invention.

FIG. 7 shows an enlarged part providing a phase difference in the liquid crystal display.

FIG. 7 illustrates the liquid crystal molecule 310, a parylene molecule 25′ included in the upper phase delay layer 25, a parylene molecule 15′ included in the lower phase delay layer 15, an internal molecule 53″ of the a-plate 53 of the upper uniaxial polarizer 21, and an internal molecule 53′ of the a-plate of the lower uniaxial polarizer 11.

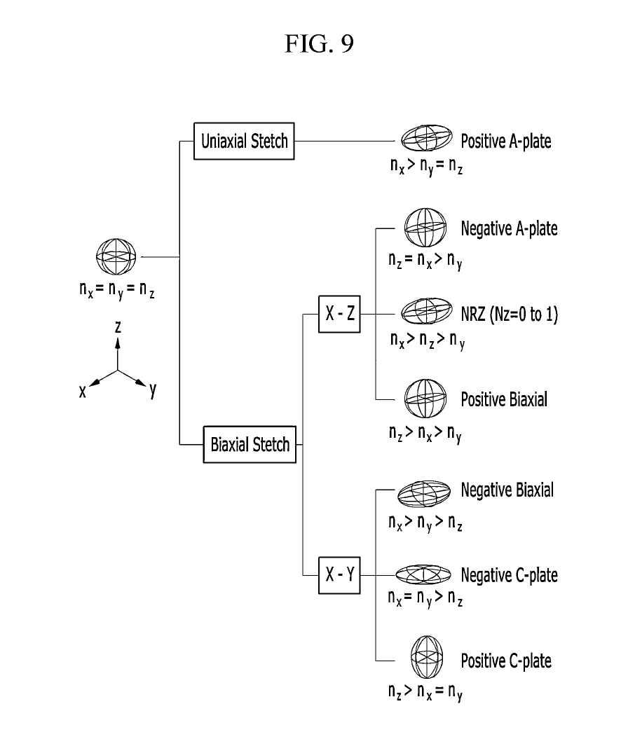

The internal molecules 53′ and 53″ of the a-plate 53 of FIG. 7 correspond to a case of a positive a-plate of FIG. 9, and parylene molecules 15′ and 25′ correspond to a negative C-plate.

In FIG. 7, when the liquid crystal molecule 310 is viewed from the side, refractive indexes of an x or y axis direction except for a z axis can be viewed by the user. Accordingly, a phase having different phase from the phase viewed from the front may be obtained. In an exemplary embodiment of the present invention, the parylene molecules 15′ an d25′ and the internal molecules 53′ and 53″ of the a-plate 53 are disposed to compensate for a difference of the generated phase difference. Here, refractive indexes of the x-axis (nx) and the y-axis (ny) of the parylene molecules 15′ and 25′ are the same, and the refractive index of the z-axis (nz) is smaller than the refractive indexes of the other axes, so that the Ro phase delay value is 0, and only the Rth phase delay value has a value. As a result, only a phase difference in the Rth direction is compensated. Meanwhile, refractive indexes of the z-axis (nz) and the y-axis (ny) of the internal molecules 53′ and 53″ of the a-plate are the same, and the refractive index of the x-axis (nx) is larger than the refractive indexes of other axes, so that the Rth phase delay value is nearly 0. As a result, only a phase difference in the Ro direction is compensated.

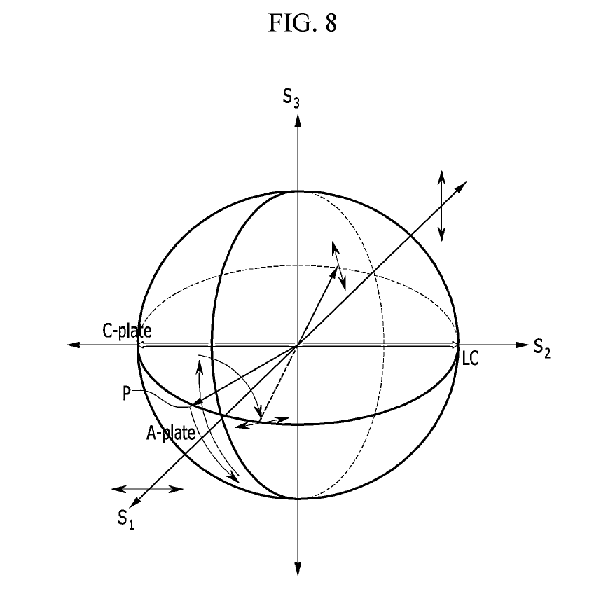

When a phase difference is compensated in the arrangement as illustrated in FIG. 7, a difference by the phase difference in various directions is not felt because the phase difference in the every direction becomes similar as illustrated in an embodiment of FIG. 8.

FIG. 9 illustrates various compensation films including uniaxial films and biaxial films.

Display characteristics of the liquid crystal display compensated as described above will be described below.

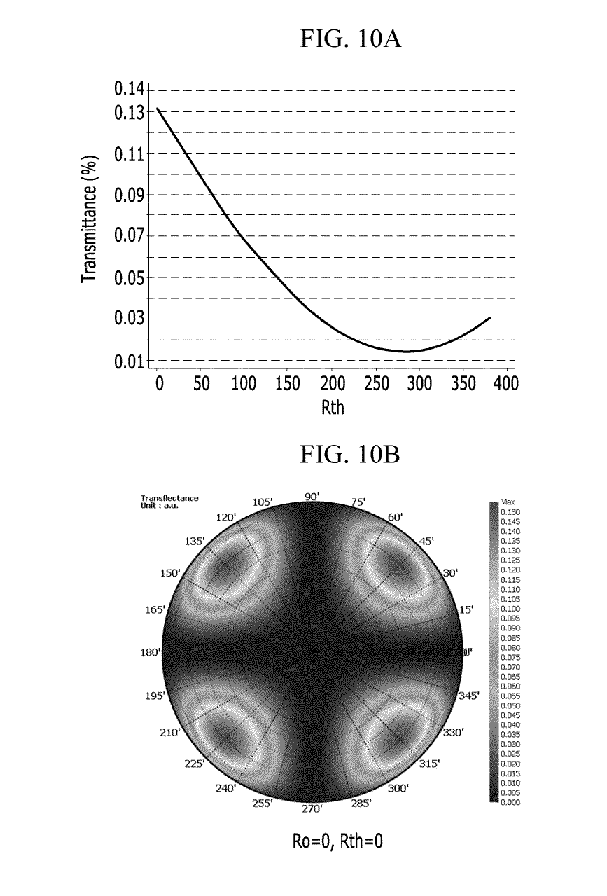

FIGS. 10A to 19 illustrate characteristics of the liquid crystal display according to an exemplary embodiment of the present invention.

First, FIGS. 10A to 12 illustrate light leakage according to a phase delay value.

When the liquid crystal molecule 310 vertically arranged as illustrated in FIG. 7 is viewed from the side, a phase delay value of the x-axis or the y-axis becomes larger, so that the light leakage may be generated. FIG. 10A illustrates light leakage in black luminance according to a change in the Rth phase delay value.

As illustrated in FIG. 10A, the light leakage in the black luminance is changed according to the Rth value and transmittance is minimized in the Rth phase delay value ranging from 250 to 300 nm, so that it can be known that the light leakage is minimum. The test is performed with a fixed Ro phase delay value. The smaller the light leakage, the better the black is displayed, but the transmittance may be equal to or smaller than a predetermined level of transmittance (for example, 0.03).

Further, as illustrated in FIGS. 10B to 10D, referring to transmittance for each position, it can be identified that light leakage is not generated in a central part since there is no or a small phase delay value in an x-axis or y-axis. The light leakage becomes larger when the angle from the x-axis or y-axis becomes 45 degree because the phase delay value in the x-axis or y-axis becomes larger in those angles. The light leakage according to the angle can be reduced by changing the Rth phase delay value. The light leakage is not nearly generated when the Rth phase delay value becomes 240 nm as illustrated in FIG. 10D.

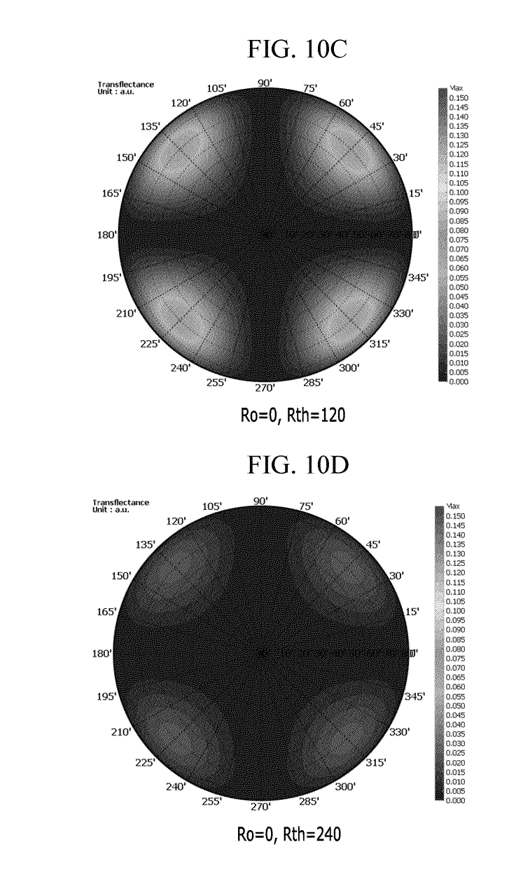

Meanwhile, FIG. 11A illustrates a change in light leakage according to the Ro phase delay value.

First, light leakage in black luminance is changed according to the Ro phase delay value and transmittance is minimized near the Ro phase delay value of 100 nm as illustrated in FIG. 11A, so that it can be known that the light leakage is minimum.

The test is performed with a fixed Rth phase delay value. The smaller the light leakage, the better the black is displayed, but the transmittance may be equal to smaller than a predetermined level of transmittance (for example, 0.03).

Further, as illustrated in FIGS. 11B to 11D, referring to transmittance for each position, it can be identified that light leakage is not generated in a central part since there is no or a small phase delay value in an x-axis or y-axis. The light leakage becomes larger when the angle from the x-axis or y-axis becomes 45 degree because the phase delay value in the x-axis or y-axis becomes larger in those angles. The light leakage according to the angle can be reduced by changing the Ro phase delay value.

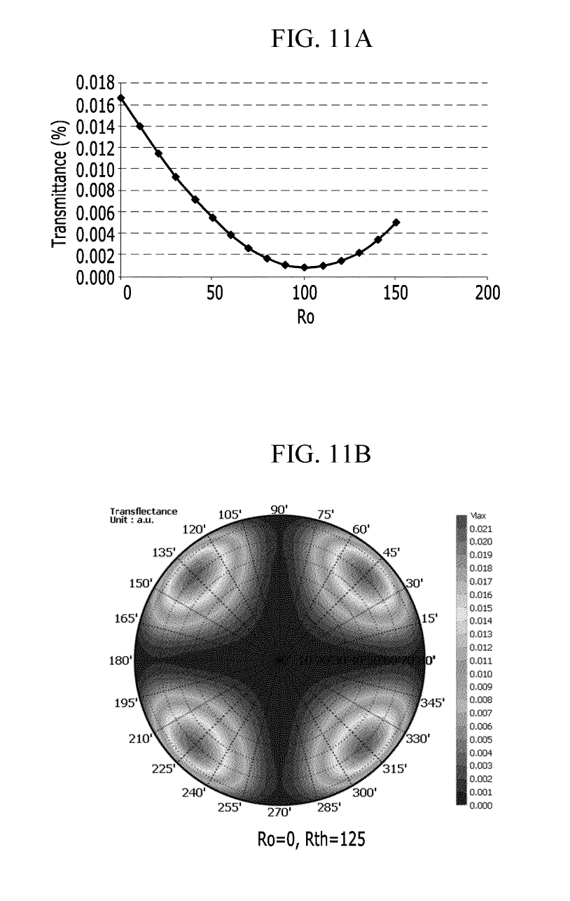

FIG. 12 illustrates retardation value according to a change in the Rth phase delay value. The graph shows a retardation value when Ro phase delay values in the upper plate and the lower plate are 0 nm and 52 nm, respectively.

As illustrated in FIG. 12, retardation value is reduced until the Rth phase delay value becomes 250 nm, which corresponds to an effect according to the Rth phase delay value. The retardation value becomes minimum when the Ro phase delay value is 52 nm.

It is possible to improve a display quality and a contrast ratio by minimizing the light leakage in displaying black by properly setting the two phase delay values.

Since the Rth phase delay value and the Ro phase delay value are values which may be changed according to embodiments, the Rth and Ro phase delay values may be set in accordance with characteristics of the display panel.

In an exemplary embodiment of the present invention, the Rth phase delay value is compensated by the upper and lower phase delay layers 25 and 15 formed by parylene, and the Ro phase delay value is compensated by the upper and lower uniaxial polarizers 21 and 11.

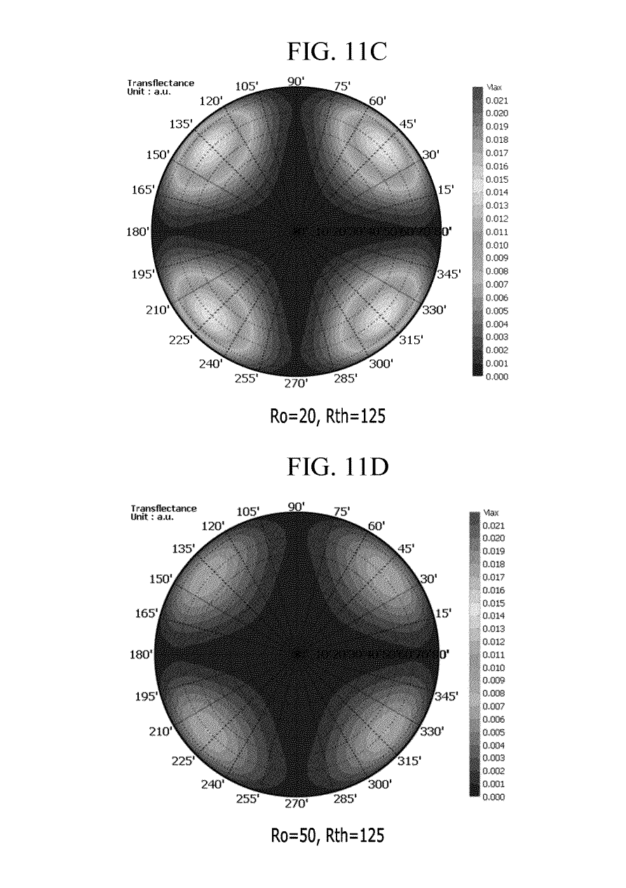

Hereinafter, a degree of the light leakage according to a thickness of parylene will be described with reference to FIGS. 13 to 17.

In FIGS. 13 to 16, the Ro phase delay value is set to 0, and thus an upper polarizer 21′ and a lower polarizer 11′ do not include the a-plate.

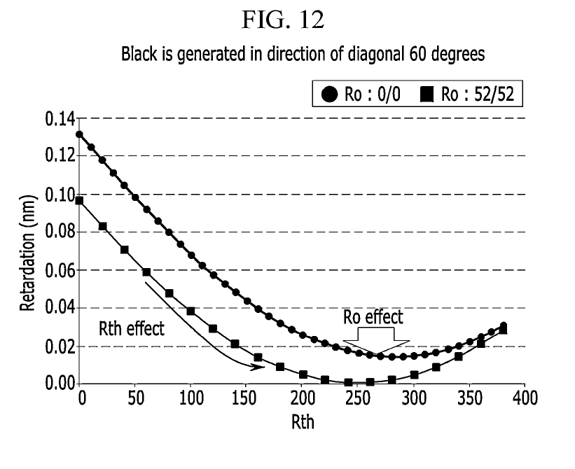

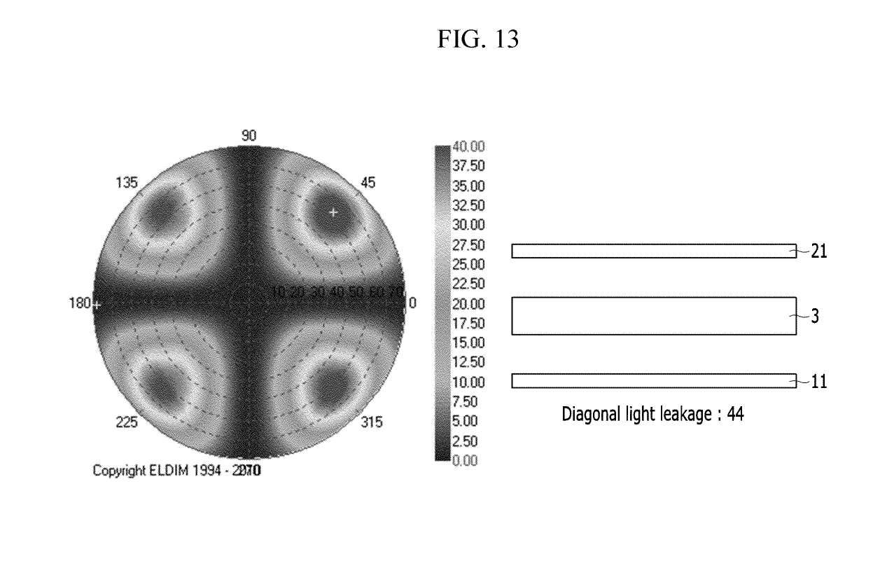

Parylene layers (that is, upper and lower phase delay layers) are not formed in FIG. 13, the upper and lower delay layers 25 and 15 corresponding to the parylene layers are formed with 1 μm in FIG. 14, the upper and lower delay layers 25 and 15 corresponding to the parylene layers are formed with 3 μm in FIG. 15, and the upper and lower delay layers 25 and 15 corresponding to the parylene layers are formed with 5 μm in FIG. 15.

Light leakage in each position is illustrated in FIGS. 13 to 16. In FIG. 13, diagonal light leakage level of 44 is generated. When the parylene layers (that is, upper and lower phase delay layers) are formed, as thicknesses of the upper and lower phase delay layers increase from 1 μm to 5 μm, the diagonal light leakage decreases from 29 to 6.

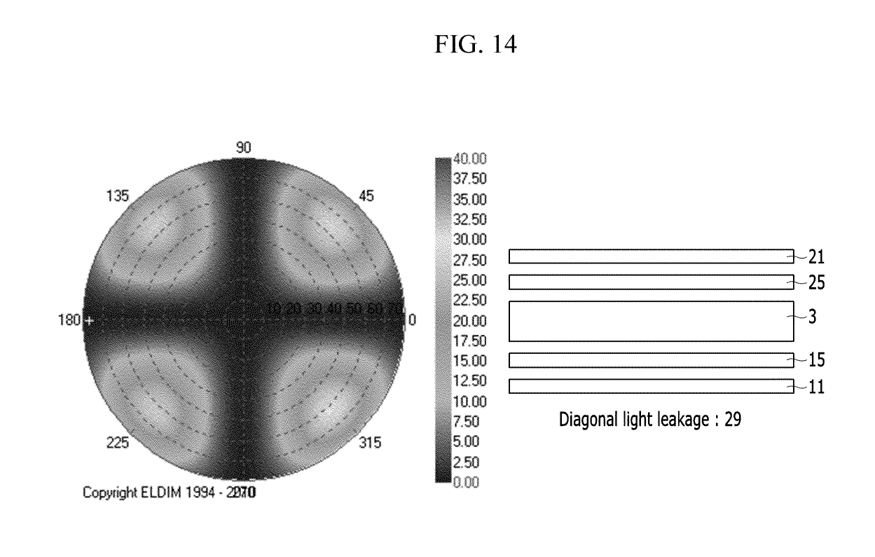

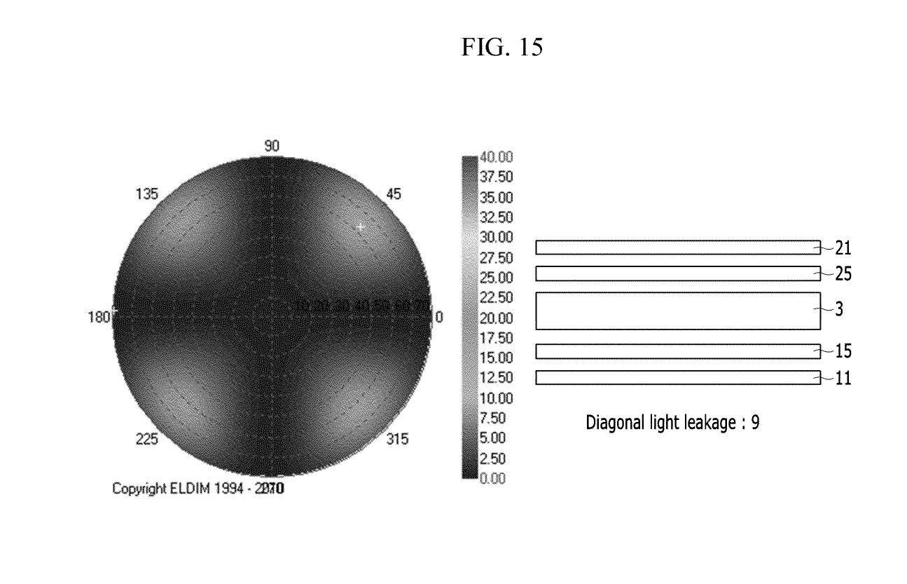

In FIG. 16, when the parylene layers (that is, upper and lower phase delay layers) of 5 μm is formed, the light leakage is greatly decrease. However, it can be known that the light leakage is relatively large in comparison with FIG. 17.

FIG. 17 illustrates a comparative example where a polarizer having a Ro phase delay value of 52 nm and a retardation film having a Rth phase delay value of 125 nm are provided on both side of the LCD panel, respectively. The comparative example shows no light leakage, however, the manufacturing cost will be increased because of the high cost of the retardation film.

In FIG. 17, it can be known that the light leakage is smaller since the Ro phase delay is also compensated. That is, it can be known that if the Ro phase delay is compensated as well in FIG. 16, the light leakage may more decrease.

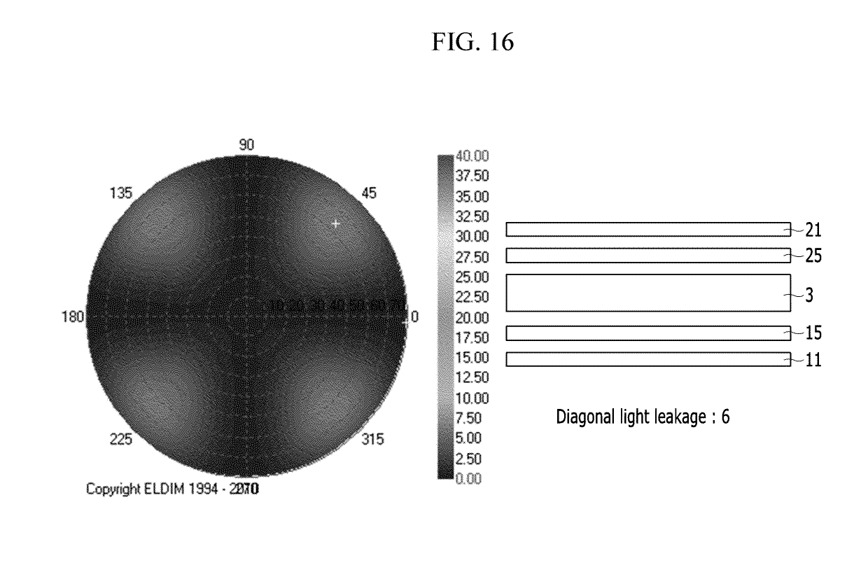

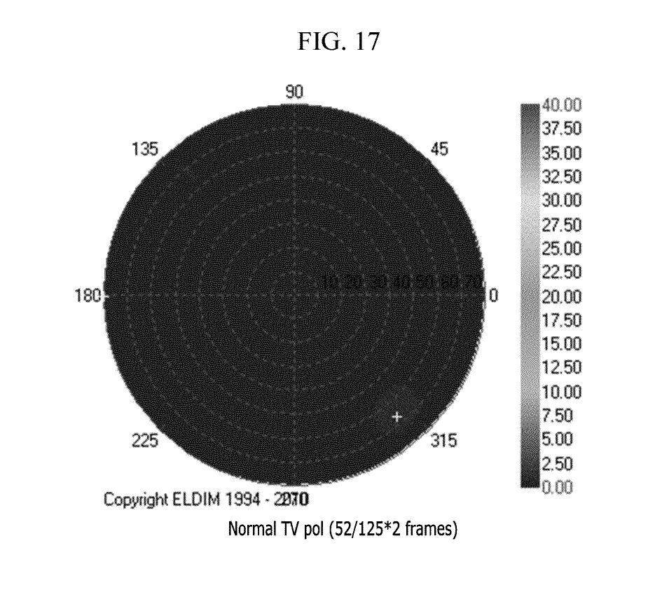

Hereinafter, a black luminance, a white luminance, and a contrast ratio will be described according to the changes in the Ro and the Rth through FIGS. 18 and 19.

In FIG. 18, the phase delay in the Ro direction is partially compensated, but the phase delay in the Rth direction is not compensated. In FIG. 19, both the phase delays in the Ro and Rth directions are compensated.

In FIG. 18, it can identified that diagonal light leakage is relatively large when displaying black, and it can be identified that compensating the phase delay in the Rth direction reduces a difference in the phase delay value viewed from the side, thereby constantly maintaining a display quality.

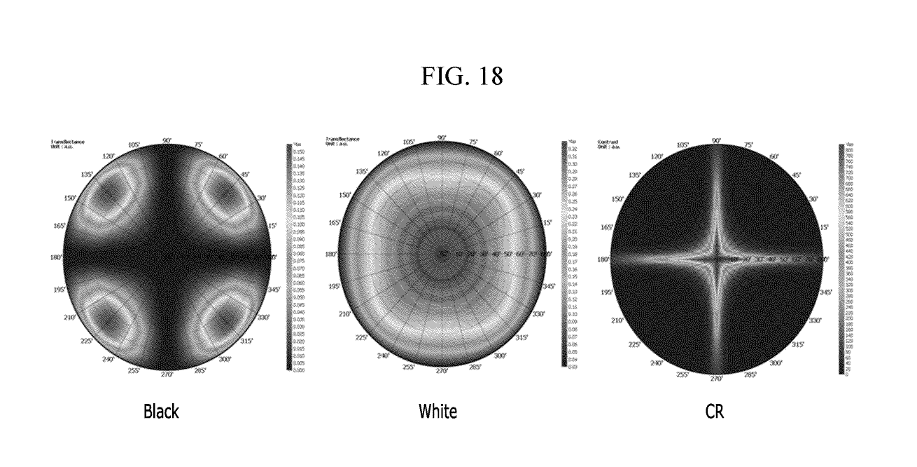

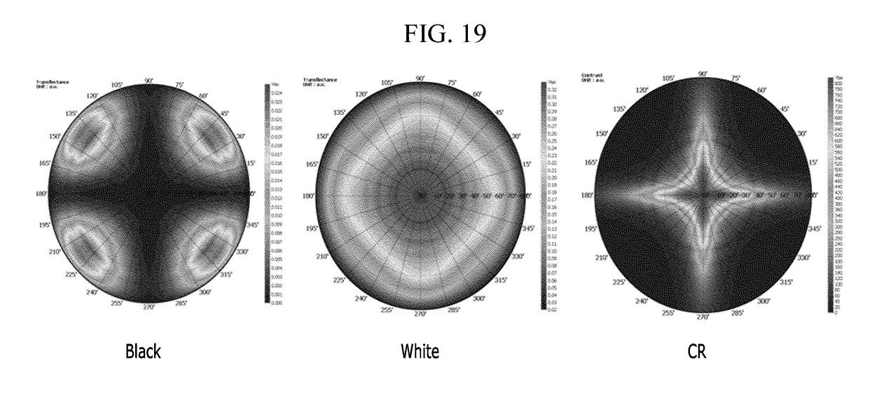

Hereinafter, another exemplary embodiment of the present invention of FIGS. 20 and 21 will be described.

FIGS. 20 and 21 are cross-sectional views of the liquid crystal display according to another exemplary embodiment of the present invention.

FIGS. 20 and 21 illustrate an exemplary embodiment where the layer including parylene is formed in one of the upper and lower layers unlike FIG. 1.

That is, in the exemplary embodiment of FIG. 20, the lower phase delay layer 15 is not included and only the upper phase delay layer 25 is included, unlike FIG. 1.

Further, in an exemplary embodiment of FIG. 21, the upper phase delay layer 25 is not included and only the lower phase delay layer 15 is included, unlike FIG. 1.

In the exemplary embodiments of FIG. 20 and FIG. 21, the phase delay layer of one side is not formed unlike the exemplary embodiment of FIG. 1, so that the phase delay in the Rth direction may not be sufficiently compensated. Accordingly, the light leakage increases in comparison with the exemplary embodiment of FIG. 1, and thus the display quality may decrease. However, it is possible to prevent the display quality from decreasing by sufficiently compensating the phase delay in the Rth direction by forming a thicker phase delay layer formed only in one side than the phase delay layer in the exemplary embodiment of FIG. 1.

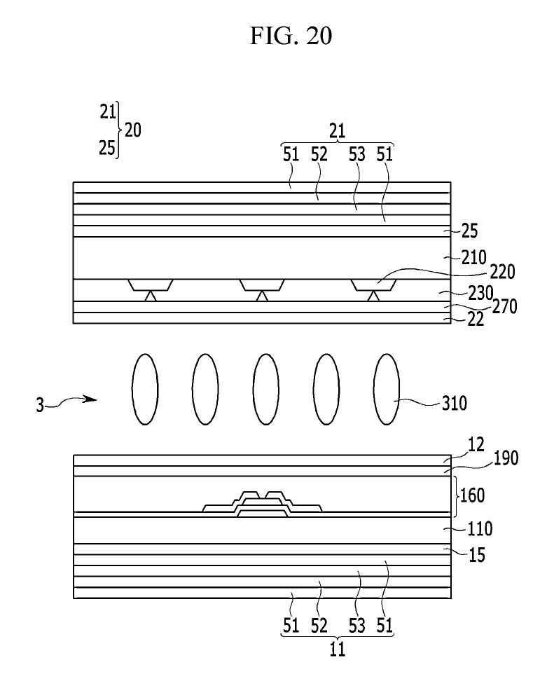

Hereinafter, the liquid crystal display according to another exemplary embodiment will be described through FIGS. 22 to 25.

FIGS. 22 to 24 illustrate the liquid crystal display and the polarizer according to another exemplary embodiment.

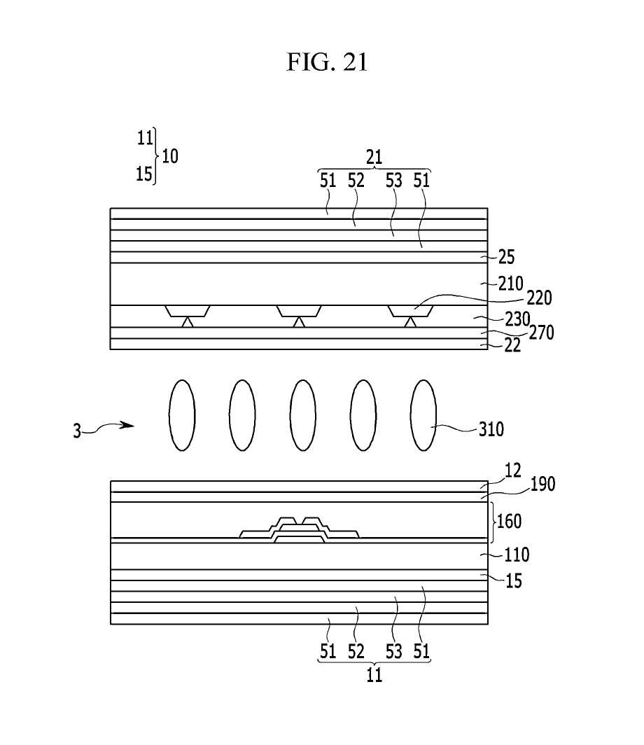

As illustrated in FIGS. 22 and 23, the liquid crystal display according to the present exemplary embodiment does not include an upper insulation substrate, and a liquid crystal layer is formed within microcavity located in the lower insulation substrate 110.

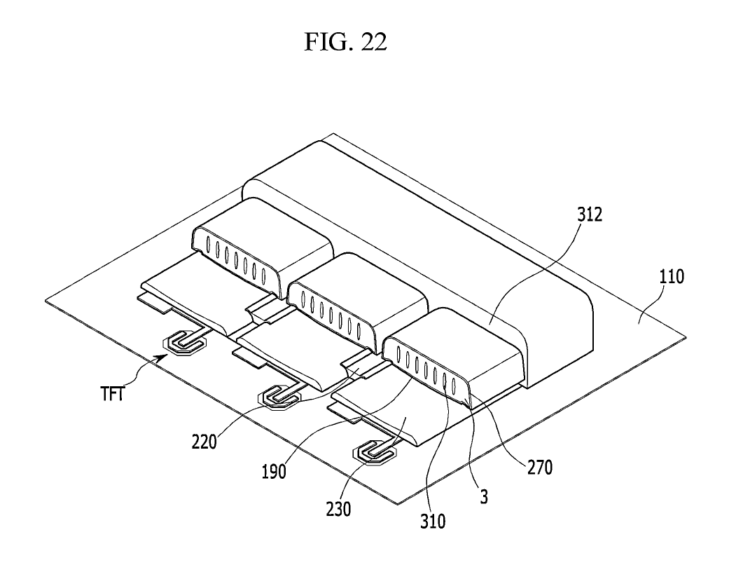

FIG. 22 is a cross-sectional perspective view of the liquid crystal display having the liquid crystal layer 3 formed within the microcavity. The lower polarizer 10 and the upper polarizer 20 are not illustrated in FIG. 22, but illustrated in FIGS. 23 and 24. Hereinafter, a structure where the liquid crystal layer is formed within the microcavity will be described through FIGS. 22 and 23.

Briefly referring to the structure in FIGS. 22 and 23, wiring and a thin film transistor (TFT) are formed on the lower insulation substrate 110 formed of a transparent glass or plastic, and the pixel electrode 190 is formed on the same layer.

The pixel electrode 190 is located within a microcavity layer, and the common electrode 170 is located on the microcavity layer. The liquid crystal layer 3 also exists within the microcavity layer. The microcavity layer is supported by an upper layer such as a roof layer 312 or the like.

Hereinafter, the structure of the liquid crystal display according to an exemplary embodiment of the present invention will be described in more detail

A gate line (not shown) is formed on the lower insulation substrate 110 formed of the transparent glass, plastic or the like. The gate line extends in one direction and protrudes, and includes a gate electrode configuring one terminal of the thin film transistor (TFT).

A gate insulating layer 140 is formed on the gate line. A semiconductor layer is formed on the gate insulating layer 140, and the semiconductor layer configures a channel of the thin film transistor (TFT).

A plurality of data lines 171 including a source electrode (a part of the thin film transistor (TFT) bent in a U shape) and a data conductor including a drain electrode (a part of the thin film transistor (TFT) in an I shape) are formed on each semiconductor and the gate insulating layer 140.

The gate electrode, the source electrode and the drain electrode forms the thin film transistor (TFT) together with the semiconductor located in a channel part.

A first passivation layer 180 is formed on the data conductor and an exposed semiconductor part. The first passivation layer 180 may include an inorganic insulation material or an organic insulation material such as silicon nitride (SiNx) and silicon oxide (SiOx).

A light blocking member (Black matrix) 220 is formed on the first passivation layer 180. The light blocking member 220 is formed based on an area where the gate line, the thin film transistor (TFT), and the data line 171 are formed, and formed in a lattice structure having an opening corresponding to an area displaying an image.

A color filter 230 is formed in the opening of the light blocking member 220. The color filters 230 having the same color are formed in adjacent pixels in a vertical direction (data line direction). Further, the color filters 230 having different colors are formed in adjacent pixels in a horizontal direction (gate line direction). In FIG. 23, two color filters 230 are spaced apart from each other with a predetermined distance on the light blocking member 220 located on the data line 171. However, according to exemplary embodiments, the two color filters 230 may overlap each other. The color filter 230 may display one of primary colors such as three primary colors including red, green and blue. However, the present invention is not limited to the three primary colors including red, green and blue, and the color filter 230 may display one of cyan, magenta, yellow, and white.

A second passivation layer 185 is formed on the light blocking member 220 and the color filter 230. The second passivation layer 185 may include an inorganic insulation material or an organic insulation material such as silicon nitride (SiNx) and silicon oxide (SiOx).

The pixel electrode 190 is formed on the second passivation layer 185. The pixel electrode 190 may be formed of a transparent conductive material such as ITO, IZO or the like.

The pixel electrode 190 is electrically connected to the drain electrode of the thin film transistor (TFT) through a contact hole formed in the passivation layers 180 and 185, and receives a data voltage.

The microcavity layer is formed on the second passivation layer 185 and pixel electrode 190, and the liquid crystal layer 3 is located in the microcavity. The liquid crystal layer 3 has dielectric anisotropy, a liquid crystal molecule may be aligned in such a manner that a long axis of the liquid crystal molecule is perpendicular to the surface of the two display panels in a state where there is not electric field.

According to exemplary embodiments, alignment layers 12 and 22 are formed in the microcavity layer. However, in order to control an initial alignment direction of the liquid crystal molecule 310, an exposure process using ultraviolet rays and the like may not be performed.

The liquid crystal layer 3 formed in the microcavity layer may be injected into the microcavity layer by using capillary force, and the alignment layers 12 and 22 may be formed by capillary force.

The common electrode 270 formed of the transparent conductive material such as ITO, IZO or the like is located on the microcavity layer. The alignment direction of the liquid crystal molecule 310 included in the liquid crystal layer 3 is changed by an electric field generated by the pixel electrode 190 and the common electrode 270.

The lower insulating layer 311 is located on common electrode 270. The lower insulating layer 311 may include an inorganic insulation material such as silicon nitride (SiNx).

The roof layer 312 is formed on the lower insulating layer 311. The roof layer 312 may support the formation of the microcavity layer.

The upper insulating layer 312 is formed on the roof layer 312. The upper insulating layer 313 may include the inorganic insulation material such as silicon nitride (SiNx).

The roof layer 312 and the upper insulating layer 313 may be patterned together with the lower insulating layer 311 to form a liquid crystal injection hole (not shown). The liquid crystal injection hole is used for removing a sacrificial layer to form the microcavity layer and to form the liquid crystal layer in the microcavity layer.

The liquid crystal injection hole is sealed by a capping layer 250 and thus a liquid crystal material does not flow to the outside.

The polarizers 10 and 20 are formed under the lower insulation substrate 110 and on the capping layer 250.

The polarizers 10 and 20 include the phase delay layers 15 and 25 and the uniaxial polarizers 11 and 21 like FIG. 1.

The liquid crystal display in FIGS. 22 and 23 include the lower insulation substrate 110 but does not include the upper insulating layer. Accordingly, the lower polarizer 10 is formed under the lower insulation substrate 110 like FIG. 1, but the upper polarizer 20 is formed on the capping layer 250 instead of on the insulation substrate unlike FIG. 1.

The upper polarizer 20 and the lower polarizer 10 according to FIGS. 22 and 23 may have the same configuration as that of FIG. 1.

That is, the lower polarizer 10 located under the lower insulation substrate 110 includes the lower phase delay layer 15 and the lower uniaxial polarizer 11. Meanwhile, the upper polarizer 20 located on the capping layer 250 includes the upper phase delay layer 25 and the upper uniaxial polarizer 21.

The upper polarizer 20 and the lower polarizer 10 according to an exemplary embodiment of the present invention include the uniaxial polarizer for compensating for the delay value in the Ro direction (in-plane phase delay value) and the phase delay layer for compensating for the delay value in the Rth direction (phase delay value in the thickness direction) in order to reduce the manufacturing costs. That is, in an exemplary embodiment of the present invention, the uniaxial polarizers 11 and 21 having the uniaxial compensation characteristic are used, and additionally formed phase delay layers 15 and 25 are used to compensate for the direction which is not compensated by the uniaxial polarizers 11 and 21.

The uniaxial polarizers 11 and 21 according to an exemplary embodiment of the present invention include the poly vinyl alcohol (PVA) layers 52 and the a-plates 53 inserted between triacetate cellulose (TAC) layers disposed in both sides as illustrated in FIG. 1. A position relation between the PVA layer 52 and the a-plate 53 may vary according to an exemplary embodiment, and the PVA layer 52 is formed above the a-plate 53 in the present exemplary embodiment.

The phase delay layers 15 and 25 according to an exemplary embodiment of the present invention are formed by depositing parylene. Since the phase delay layers 15 and 25 determine the delay value in the Rth direction (phase delay value in the thickness direction) according to a thickness of the deposited parylene, once the delay value to be compensated for is determined, the phase delay layers 15 and 25 may be formed by depositing parylene having a proper thickness. As a result, the phase delay layers 15 and 25 may easily have the compensation characteristics.

According to exemplary embodiments, directions of transmission axes of the upper polarizer 20 and the lower polarizer 10 may be perpendicular or parallel to each other.

Meanwhile, at least one of the uniaxial polarizers 11 and 21 of the upper polarizer 20 and the lower polarizer 10 used in FIGS. 22 and 23 may have a structure of FIG. 24.

FIG. 24 illustrates a cross sectional structure before the upper polarizer 20 and the lower polarizer 10 are attached to the liquid crystal display. A protective film 57 and a release film 56 are films attached to an external side to protect a part used in the actual liquid crystal display by a manufacturing company of the uniaxial polarizer. Accordingly, only internal components of the uniaxial polarizer are attached to the uniaxial polarizer of the liquid crystal display and used.

The polarizers 11 and 21 of FIG. 24 also include the TAC layer 51, the PVA layer 52, and the a-plate 53 like FIG. 1

The PVA layer 52 is located only between the a-plate 53 and the TAC layer 51 unlike FIG. 1. However, according to exemplary embodiments, the PVA layer 52 may be located in both sides of the a-plate 53.

A pressure sensitive adhesive (PSA) layer 54 is located under the a-plate 53. The PSA layer 54 is a layer attached to the phase delay layer to which the uniaxial polarizer is attached after the release film 56 is removed.

Meanwhile, a surface-treatment layer 55 is located on the TAC layer 51. The surface-treatment layer 55 is a layer to prevent light reflection or generation of the static electricity by performing an anti-reflection treatment, anti-glare treatment, or anti-static treatment.

When the structure of FIG. 24 is applied to the upper uniaxial polarizer 21, the structure of FIG. 24 except for the release film 56 and the protective film 57 may be located on the upper phase delay layer 25. However, when the structure of FIG. 24 is applied on the lower uniaxial polarizer 11, an upside down structure of the structure of FIG. 24 except for the release film 56 and the protective film 57 may be located under the lower phase delay layer 15.

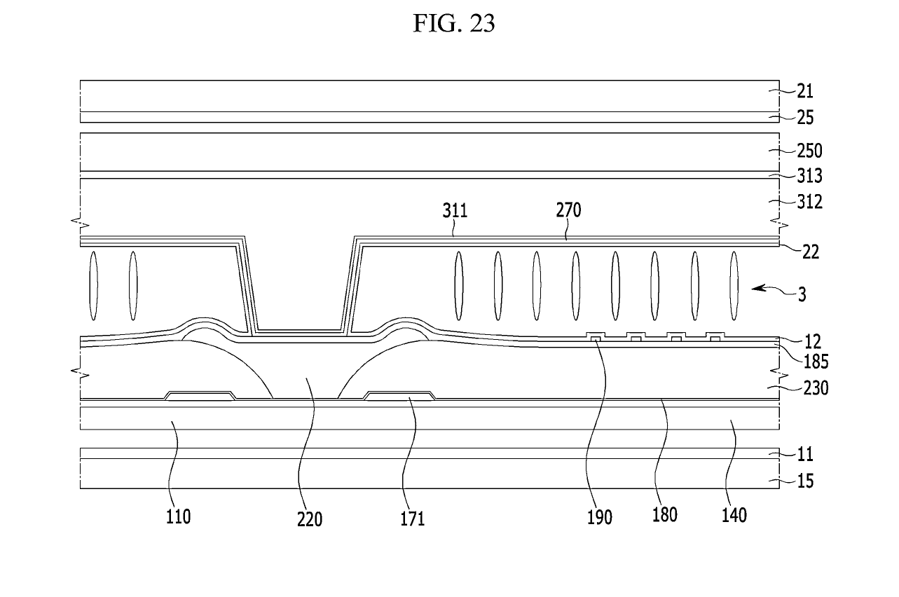

Hereinafter, a method of forming the phase delay layer by deposing parylene will be described in more detail with reference to FIGS. 25 to 31 FIG.

FIGS. 25 to 31 illustrate the method of depositing parylene according to an exemplary embodiment of the present invention.

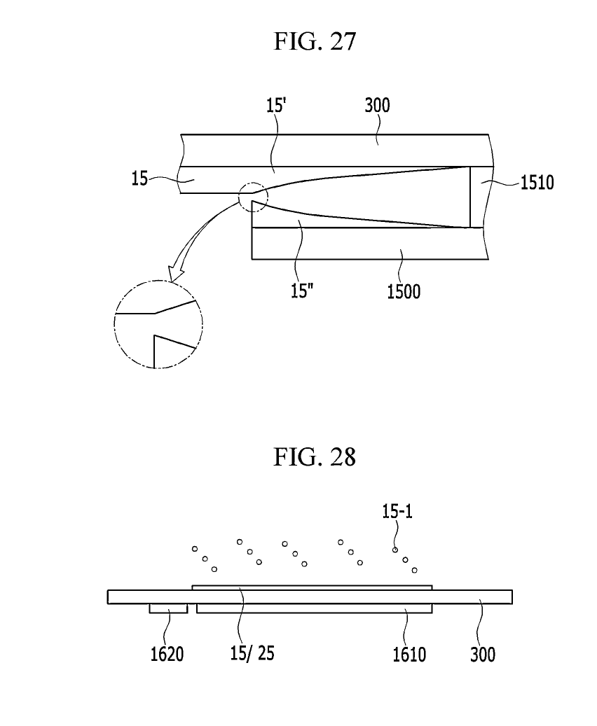

There may be various methods of forming the phase delay layer by deposing parylene, but methods described below according to an exemplary embodiment of the present invention include a method of depositing parylene on a part which is not covered by a mask (see FIGS. 25 to 27) and a method of selectively depositing parylene by a temperature difference (see FIGS. 28 to 31).

First, the method of depositing parylene on the part which is not covered by the mask will be described with reference to FIGS. 25 to 27.

FIG. 25 illustrates a cross section of a structure where parylene is deposited only on one side of the display panel 300.

The structure supporting the display panel 300 includes a support member 1500 having an opening where parylene is deposited and a rubber magnet member 1550 for supporting the display panel 300 in an opposite side of the support member 1500. The rubber magnet member 1550 of FIG. 25 does not include the opening and thus, prevent the display panel 300 from deposition of the parylene.

The support member 1500 and the display panel 300 do not directly come into contact with each other, and a silicon pad 1510 is located between the support member 1500 and the display panel 300 to allow the support member 1500 to support the display panel 300.

When a parylene molecule 15-1 is deposited in a state where the display panel 300 is supported as illustrated in FIG. 25, parylene is deposited on one surface of the display panel 300 through the opening of the support member 1500 to form the phase delay layer 15 or 25. Parylene is not deposited on the part covered by the rubber magnet member 1550. Accordingly, depositing equipment of parylene as illustrated in FIG. 25 may be applied to the case where the phase delay layer is formed in one of the upper layer and the lower layer as illustrated in FIG. 20 or 21.

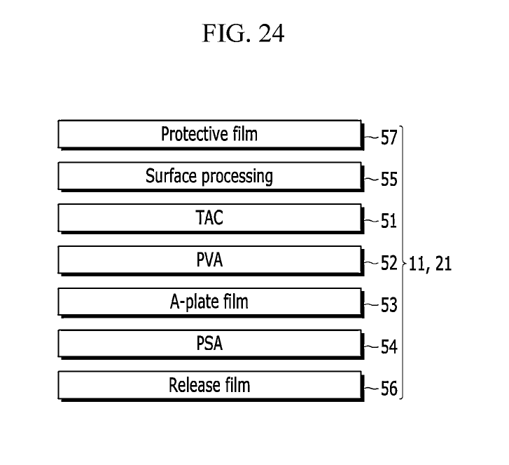

Meanwhile, FIG. 26 illustrates a cross section of a structure where parylene can be deposited on both sides of the display panel 300.

The structure of FIG. 26 is similar to that of FIG. 25, but a rubber magnet member 1550-1 includes the opening. As a result, the parylene molecule 15-1 is deposited on the both sides of the display panel 300 to form both the upper phase delay layer 25 and the lower phase delay layer 15. The rubber magnet member 1550-1 and the display panel 300 do not directly come into contact with each other, and the silicon pad 1510 is located between the support member 1500 and the display panel 300 to allow the rubber magnet member 1500-1 to support the display panel 300.

Depositing equipment of parylene of FIG. 26 may be used for the case where the phase delay layers are formed on both the upper and lower layers as like FIG. 1.

When parylene is deposited on an opened part such as the opening as illustrated in FIGS. 25 and 26, parylene is also deposited on an internal surface of the support member 1500 or the rubber magnet member 1550-1. Parylene is deposited on the internal surface of the support member 1500 or the rubber magnet member 1550-1 through a small hole or the opened part, and a thickness of deposited parylene becomes thinner as it is far from the small hole or the opened part.

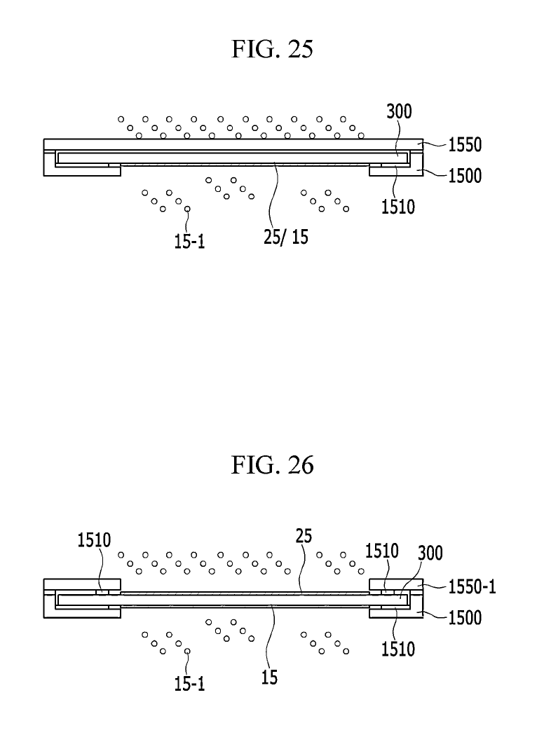

As a result, when the phase delay layer 15 is deposited by depositing parylene through the opened part corresponding to the opening of the support member 1500 as illustrated in FIG. 27, parylene is deposited on an upper part of the display panel 300 covered by the support member 1500, an internal side surface of the support member 1500, and a side surface of the silicon pad 1510. Accordingly, the silicon pad 150 can cover a part where parylene should not be deposited in the display panel 300 (for example, gate line, or a pad unit or a driving circuit for applying a signal to the data line).

Further, an amount of deposited parylene or a distance between the support member 1500 and the display panel 300 may be adjusted to make parylene deposited on the upper part of the display panel covered by the support member 1500 not meet parylene deposited on the internal side surface of the support member 1500. When parylene deposited on the upper part of the display panel covered by the support member 1500 meets parylene deposited on the internal side surface of the support member 1500, a part of the phase delay layer 15 formed one the display panel 300 may be removed together when the support member 1500 is removed.

Hereinafter, the method of selectively depositing parylene by a temperature difference will be described with reference to FIGS. 28 to 30.

As illustrated in FIG. 28, a cooling part 1610 and a heating part 1620 are located under the display panel 300. At this time, the parylene molecule 15-1 is deposited on the display panel 300 cooled by the cooling part 1610 to form the phase delay layer 15 or 25, and is not deposited on the display panel 300 heated by the heating part 1620. As described above, parylene may be selectively deposited by the temperature. Here, the cooling part 1610 provides a temperature lower than or equal to 10 degrees, and the heating part 1620 provides a temperature lower than or equal to 100 degrees and higher than 10 degrees to generate a temperature difference on the display panel 300.

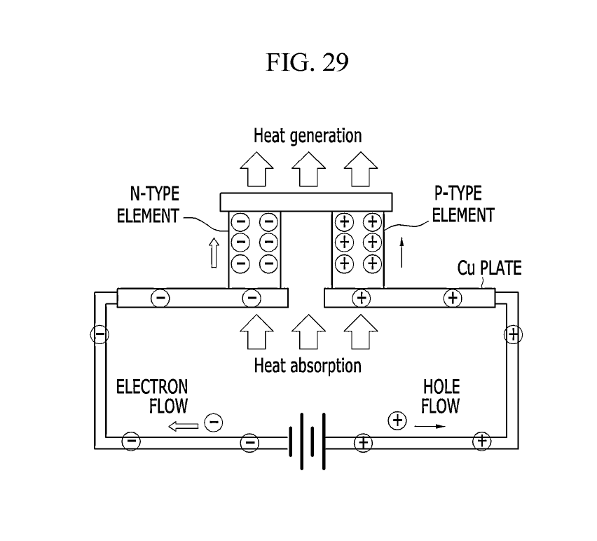

The cooling part 1610 and the heating part 1620 used in FIG. 28 may be formed by a thermoelectric element, and the thermoelectric element is illustrated in FIG. 29.

As illustrated in FIG. 29, the thermoelectric element has a structure by a PN junction where one side generates a heat and the other side absorbs a heat. The side absorbing the heat of the cooling part 1610 is disposed to be adjacent to the display panel 300, and the side generating the heat of the heating part 1620 is disposed to be adjacent to the display panel 300.

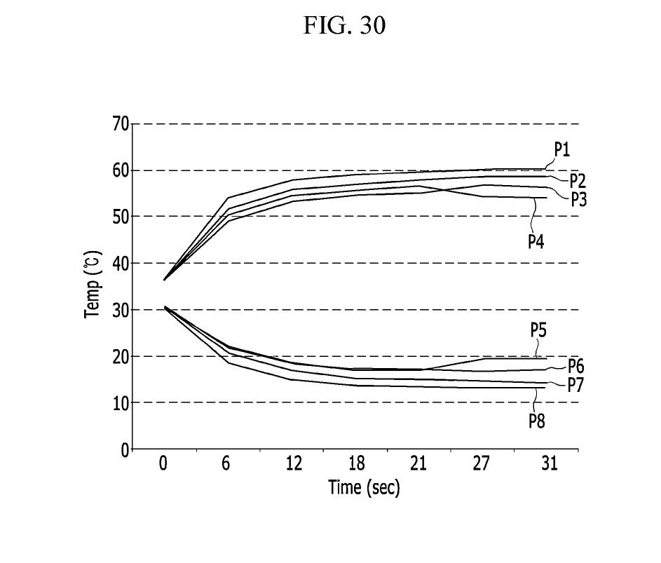

The thermoelectric element of FIG. 29 shows a temperature change according to a time as illustrated in FIG. 30.

FIG. 30 shows values measured by experimenting with a total of eight thermoelectric elements P1 to P8, wherein a horizontal axis corresponds to a time in the unit of seconds (sec) and a vertical axis corresponds to a temperature. Four thermoelectric elements P1 to P4 of a total of eight thermoelectric elements measure the side generating the heat, and the remaining four thermoelectric elements P5 to P8 measure the side absorbing the heat.

As illustrated in a graph of FIG. 30, both the side generating the heat and the side absorbing the heat have a saturated temperature within 30 seconds. Accordingly, it does not take a long time to provide a temperature difference to the display panel 300, so that it is possible to easily provide the temperature difference and selectively deposit parylene.

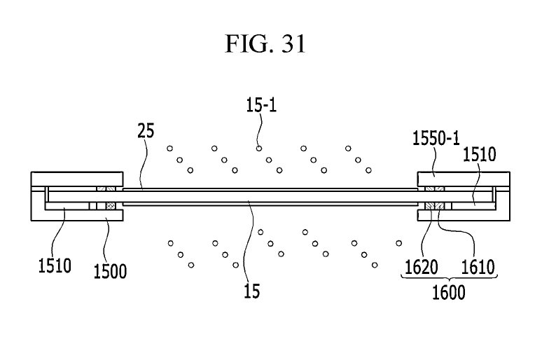

Meanwhile, FIG. 31 illustrates a method combining the above two methods. That is, in FIG. 31, a support structure including the support member 1500 and the like supports the display panel 300, and parylene is selectively deposited using the cooling part 1610 and the heating part 1620 using the thermoelectric element 1600.

The structure of FIG. 31 is the same as that of FIG. 26, so that parylene may be deposited on both sides of the display panel 300.

In an exemplary embodiment of FIG. 31, parylene is deposited on the opening of the support member 1500, and parylene may continuously be deposited or may not be additionally deposited by controlling a total temperature of the display panel 300 through a control of the cooling part 1610 or the heating part 1620.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal display panel comprising a first substrate and a liquid crystal layer;
an upper polarizer disposed on the liquid crystal display panel;
a lower polarizer disposed under the liquid crystal display panel; and
a first phase delay layer located on the liquid crystal display panel and configured to compensate for a phase delay value in a thickness direction,
wherein the first phase delay layer comprises parylene.

2. The liquid crystal display of claim 1, further comprising a second substrate formed opposite to the first substrate and having the liquid crystal layer between the first substrate and the second substrate,
wherein the first phase delay layer is deposited on the liquid crystal panel.

3. The liquid crystal display of claim 2, wherein the first phase delay layer is directly deposited on the liquid crystal panel without an intervening adhesive layer.

4. The liquid crystal display of claim 3, wherein the first phase delay layer has an out-of-plane retardation value equal to or greater than a half of the retardation value of the liquid crystal and equal to or less than 1.5 times of the retardation value of the liquid crystal.

5. The liquid crystal display of claim 2, wherein the first phase delay layer has an out-of-plane retardation value equal to or greater than a half of the retardation value of the liquid crystal and equal to or less than 1.5 times of the retardation value of the liquid crystal.

6. The liquid crystal display of claim 1, further comprising:
a second substrate formed opposite to the first substrate and having the liquid crystal layer between the first substrate and the second substrate;
a second phase delay layer located on the liquid crystal display panel where the first phase delay layer is not formed, and configured to compensate for a phase delay value in a thickness direction,
wherein the second phase delay layer comprises parylene.

7. The liquid crystal display of claim 6, wherein the second phase delay layer is deposited on the second substrate.

8. The liquid crystal display of claim 7, wherein the second phase delay layer is directly deposited on the second substrate without an intervening adhesive layer.

9. The liquid crystal display of claim 8, wherein each of the upper phase delay layer and the lower phase delay layer has an out-of-plane retardation value equal to or greater than a quarter of the retardation value of the liquid crystal and equal to or less than 0.75 times of the retardation value of the liquid crystal.

10. The liquid crystal display of claim 8, wherein each of the upper phase delay layer and the lower phase delay layer has an out-of-plane retardation value equal to or greater than a quarter of the retardation value of the liquid crystal and equal to or less than 0.75 times of the retardation value of the liquid crystal.

11. The liquid crystal display of claim 1, further comprising a microcavity layer supported by a roof layer formed on the first substrate, and the liquid crystal layer is located within the microcavity layer.

12. The liquid crystal display of claim 11, wherein the first phase delay layer is directly deposited on the liquid crystal panel without an intervening adhesive layer.

13. The liquid crystal display of claim 12, wherein the first phase delay layer has an out-of-plane retardation value equal to or greater than a half of the retardation value of the liquid crystal and equal to or less than 1.5 times of the retardation value of the liquid crystal.

14. The liquid crystal display of claim 1, further comprising:
a second phase delay layer disposed on the roof layer, and configured to compensate for a phase delay value in a thickness direction,
wherein the second phase delay layer comprise parylene.

15. The liquid crystal display of claim 14, wherein each of the upper phase delay layer and the lower phase delay layer has an out-of-plane retardation value equal to or greater than a quarter of the retardation value of the liquid crystal and equal to or less than 0.75 times of the retardation value of the liquid crystal.

16. A method of manufacturing a liquid crystal display, the method comprising:
forming a phase delay layer by depositing parylene on a liquid crystal display panel; and
attaching an uniaxial polarizer on the deposited phase delay layer,
wherein the phase delay layer compensates for an out-of-plane phase delay value.

17. The method of claim 16, wherein
the forming a phase delay layer comprises depositing the parylene in a state where the liquid crystal display panel is supported by a support member having an opening,
wherein the opening corresponds to an area where the parylene is deposited in the liquid crystal display panel.

18. The method of claim 17, wherein the forming a phase delay layer comprises depositing the parylene by reducing a temperature of the area where the parylene is deposited and increasing a temperature of an area where the parylene is not deposited,
wherein a heating and a cooling is performed by a thermoelectric element.

19. The method of claim 18, wherein the forming a phase delay layer comprises forming phase delay layers on both side of the liquid crystal display panel and the attaching an uniaxial polarizer comprises attaching uniaxial polarizers on both side of the liquid crystal panel.

20. The method of claim 16, wherein the forming of the phase delay layer comprises depositing the parylene by reducing a temperature of the area where the parylene is deposited and increasing a temperature of an area where the parylene is not deposited,
wherein a heating and a cooling is performed by a thermoelectric element.
